(19) United States
(12) Patent Application Publication
(10) Pub. No.: US 2008/0221946 A1
(43) Pub. Date: Sep. 11, 2008

(54) METHOD AND SYSTEM FOR EVALUATING AND SUMMARIZING WEEKLY PROJECT PROGRESS

(76) Inventor: Robert Balon, Winnetka, IL (US)

Correspondence Address: MERCHANT & GOULD PC, P.O. BOX 2903, MINNEAPOLIS, MN, 55402-0903, US

(21) Appl. No.: 11/969,519

(22) Filed: Jan. 4, 2008

Related U.S. Application Data
(60) Provisional application No. 60/878,747, filed on Jan. 5, 2007.

(51) Int. Cl. G06Q 10/00

(52) U.S. Cl. 705/7

(57) ABSTRACT

The present invention provides a method and system for evaluating and summarizing weekly project progress. The method provides a process for determining and summarizing project progress based on the weekly status of project tasks. The system provides a process operating on a computer system, which includes a computer, a common spreadsheet application, and a software program, operable in combination to graphically represent summarized project progress information based on the weekly status of project tasks.

### RELATED APPLICATION

### Priority Claim

This application claims the benefit of U.S. Provisional Patent Application Ser. 60/878,747, entitled “METHOD AND SYSTEM FOR EVALUATING AND SUMMARIZING WEEKLY PROJECT PROGRESS,” filed on Jan. 5, 2007. This application claims the benefit of the previously filed application under 35 U.S.C. § 119.

### BACKGROUND

A project may be thought of as a collection of project tasks with a common set of project objectives, a project start date, and a project completion date. Project tasks may be thought of as portions of projects and project activities that have individual resources, task start dates, and task completion dates. The successful and timely completion of a project relies on the successful and timely completion of the individual tasks that comprise the project. A project start date may be thought of as the earliest task start date from the project's collection of tasks. A project completion date may be thought of as the latest task completion date from the project's collection of tasks. The project elapsed time may be thought of as the difference between the project start date and the project completion date. The project status date may be thought of as the effective date of obtaining the status of the progress of the project. A project may be considered complete when the last task is considered complete.

Tracking the progress of a project may be thought of as understanding what portion of the project is complete relative to the portion that remains. A useful technique in tracking the progress of a project is to understand the progress of each underlying task that comprises the project. The overall progress of a project can be determined by aggregating the progress of individual tasks.

Most project management methods and techniques track progress based on completion percentage. In fact, most project management methods and tools support the tracking of progress by using a completion percentage that can be associated with each task. The overall project completion percentage is often estimated by averaging the completion percentages of each task in a project, where individual tasks may have completion percentages ranging from 0% to 100%. Common project management methods and tools may even weigh task completion percentages based on effort. Task effort may be thought of as the combination of people and duration assigned to an individual task.

### SUMMARY OF THE INVENTION

This Summary is provided to introduce a selection of concepts in a simplified form that are further described below in the Detailed Description. This Summary is not intended to identify key features or essential features of the subject matter to be claimed, nor is it intended to be used as an aid in determining the scope of the subject matter to be claimed.

The present disclosure is directed to a methods, systems, and computer-implemented methods and media for evaluating and summarizing weekly project progress. The method provides a process for determining and summarizing project progress based on the weekly status of project tasks. The system provides a process operating on a computer system, which includes a computer, a software program, and in some implementations a spreadsheet application, operable in combination to graphically represent summarized project progress information based on the weekly status of project tasks.

These and other features and advantages will be apparent from reading the following detailed description and reviewing the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

In the drawings, like numerals represent like elements. In addition, the first digit in three-digit reference numerals and the first two-digits in four-digit reference numerals refer to the figure in which the referenced element first appears.

FIG. 1 shows the current method and system embodiment of the invention, including source information obtained from external project plans, a user interface, a weekly project evaluation computer program, an underlying commonly available spreadsheet application, a computer with a display monitor, output, and a process, or collection of procedures, associated with the invention;

FIG. 2A shows the weekly project evaluation tool, with all of the detailed components a user can specify;

FIGS. 2B-2H show enlarged views of portions of the weekly project evaluation tool illustrated in FIG. 2A;

FIG. 3 shows the weekly project evaluation tool, with the date fields hidden;

FIG. 4 shows the project sheet of the weekly project evaluation tool as visible to the user from a spreadsheet application; and

FIG. 5 shows the executive view of the weekly project evaluation tool, which summarizes weekly project evaluation tool information into an executive top-level view of progress across multiple projects;

FIG. 6 shows the parameters view associated with the weekly project evaluation tool, which is used to specify the parameters and cell references used by the weekly project evaluation tool to generate the graphical representation of the weekly view; and

FIG. 7 shows an exemplary printed output from the weekly project evaluation tool presenting an executive summary view;

FIG. 8 shows an exemplary printed output from the weekly project evaluation tool presenting a project view;

FIG. 9 is a flow diagram of a computer-implemented process of by which a computing system facilitates a process of weekly project evaluation;

FIG. 10 is a flow diagram of a process by which a user performs weekly project evaluation; and

FIG. 11 is a block diagram of a computing environment on which a computer-implemented version of the weekly project evaluation tool may be executed.

### DETAILED DESCRIPTION OF IMPLEMENTATIONS

This detailed description describes implementations of evaluating and summarizing project progress on a weekly basis. The presentation of project information based on the weekly completion of project tasks is a different approach than is conventionally used.

By way of distinction, there are several issues with conventional methods of determining project progress. First, averaging the completion percentages of project tasks assumes all tasks involve the same degree of effort. In reality, project tasks are not identical and involve varying degrees of effort, complexity, constraints, dependencies, and organizational considerations. Progress on one task is not necessarily representative of progress on another task. For example, if two project tasks are 50% complete and have the same duration, they do not necessarily have the same complexity or other considerations.

Second, determining project progress based on completion percentage assumes the project completion percentage correlates to the percentage of the project elapsed time consumed based on the calendar time between the project start date and the project status date. For example, if 50% of a project is estimated to be complete, and 50% of the project elapsed time has been consumed, this would commonly be regarded as on schedule. However, this also assumes that the remaining 50% of the project involves the same degree of effort, complexity, and constraints. In reality, progress on the completed portion of a project is not necessarily representative of how progress will proceed on the remaining portion.

Third, estimating how long the remaining portion of a project will take based on the project completion percentage to date assumes progress is linear and that every portion of a project progresses at the same rate. For example, if 50% of a project is complete and effort is constant, most common project management methods and tools would suggest that it will take the same amount of time to complete the remaining portion of the project. In reality, it is difficult to reflect the true complexity and considerations in task effort estimates and project progress is rarely linear.

In implementations for weekly project evaluation and summarization, progress tracking is based on weekly milestones and the expected completion dates of planned tasks. Rather than mathematically relying on the weighted average of task completion percentages, this invention involves a method that, on a weekly basis, reassesses two attributes: (1) which tasks have been completed; and (2) what are the estimated completion dates of remaining tasks.

The method may be thought of as reassessing the weekly execution of project tasks. The weekly execution of project tasks may be thought of as understanding which tasks have been completed, rescheduled, or assessed for estimated completion dates in weekly increments.

This method may be performed manually, but, understandably, is made more efficient and effective using a computer-implemented form, which automates the process of tracking and summarizing weekly project progress. The weekly basis may be thought of as a reference to the calendar and time interval used to track the progress of projects and tasks, not solely as a reference of the frequency of evaluating progress.

### Overview of an Implementation of Weekly Project Evaluation

The following description details one implementation of weekly project evaluation that is illustrative of the invention. Some variations of weekly project evaluation and summarization are also described. In any case, this description is provided for the sake of illustration, and should not be considered to limit the scope of the invention exemplified in this description.

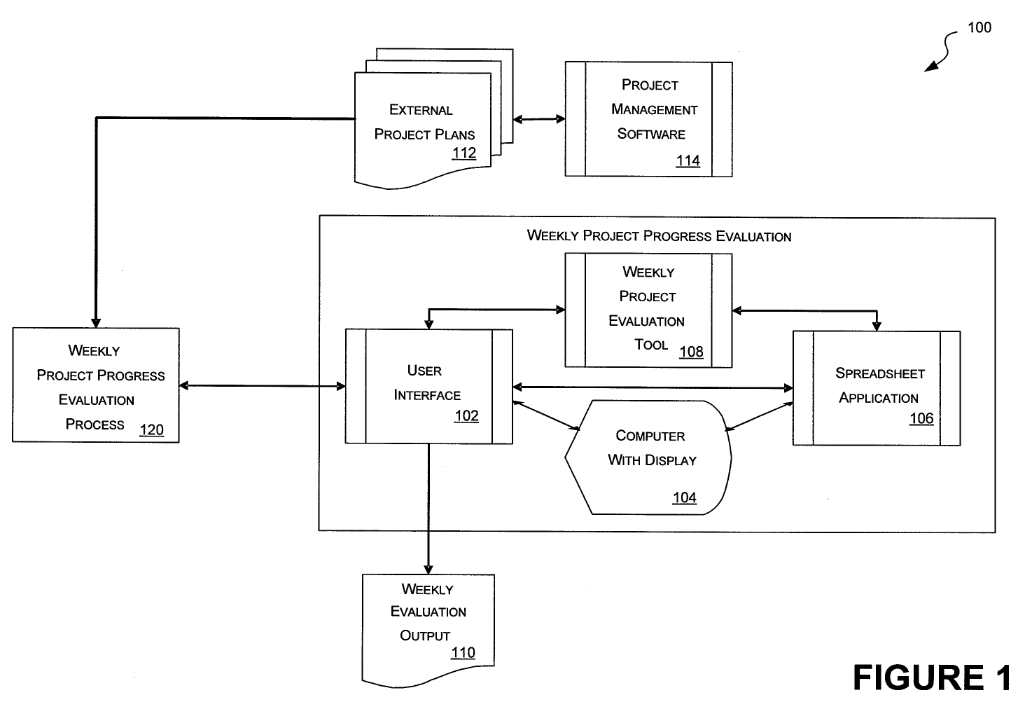

As shown in FIG. 1, weekly project evaluation is presented as a screen display presented by a computing system executing a computer-implemented method or following instructions stored on a computer-readable medium. A weekly project evaluation system 100 includes a user interface 102 presented by a computing system with an associated display monitor 104. In one implementation, the computing system 104 supports a spreadsheet application 106 that is used to automate some of the calculations and presentation tasks under the control of a weekly project evaluation tool 108. The weekly project evaluation tool 108 is operable in combination to graphically represent summarized project progress information based on the weekly completion of project tasks. The user interface 102, in one implementation, is a specifically formatted spreadsheet file that contains cells at the intersection of rows and columns. Using the user interface 102, a user can activate other computer programs and macros, including the weekly project evaluation tool 108, to perform the functions specified in this invention. In one implementation, the weekly project evaluation tool includes a collection of Visual Basic (VB) computer programs in the form of macros that function with a Microsoft Excel® spreadsheet application, but can function with any common spreadsheet application that supports the use of macros. The current embodiment involves VB macros, but the described invention can be automated with any computer language, and may be implemented as a standalone software system that operates without a spreadsheet application.

The weekly evaluation tool 108 is operable to generate weekly evaluation output 110 which can be presented via the user interface 102 and/or in a printed form. The weekly evaluation output 110 summarizes weekly progress, as is explained further below. The weekly evaluation output 110 can be used alone, or can be included along with the results of other external project plans 112 and/or project management software 114 as part of a weekly project progress evaluation process 120. The information from the external project plans 112 and/or project management software 114, as described above, does not present weekly evaluation information as is included in the weekly evaluation output 110.

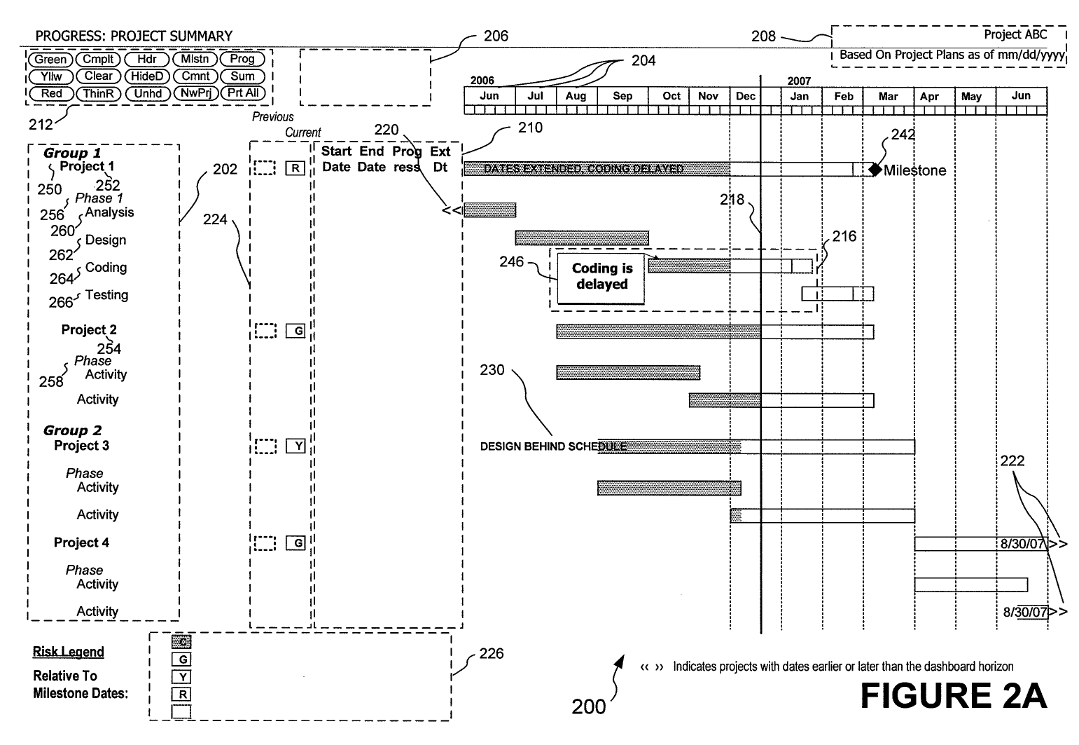

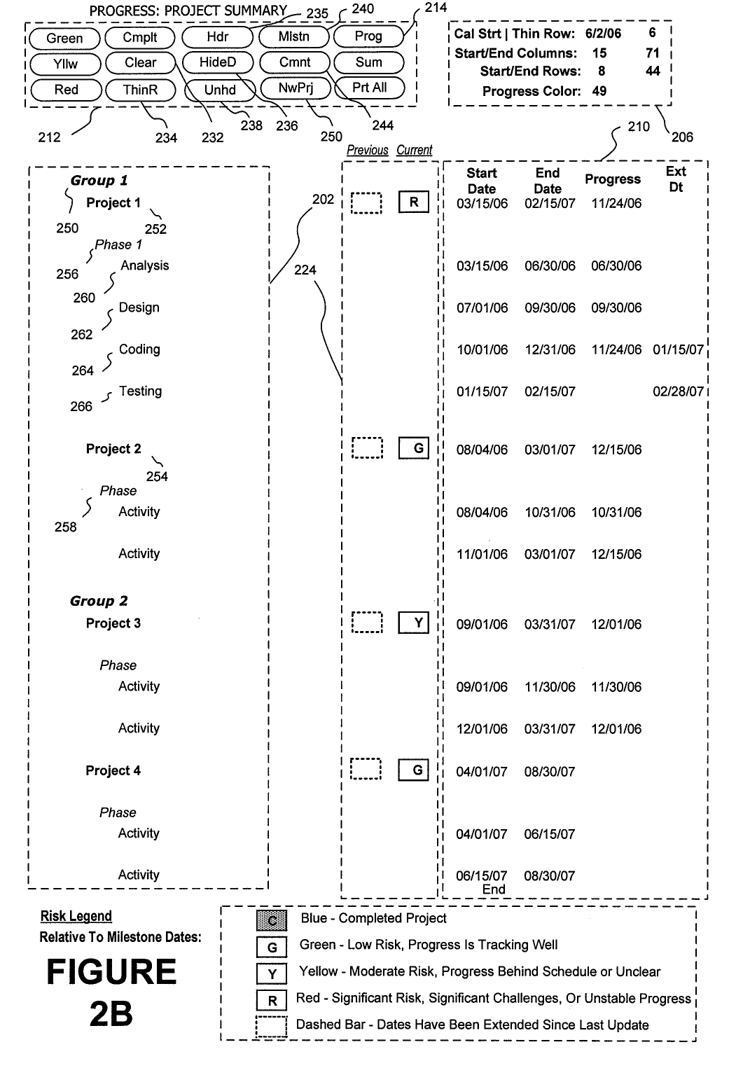

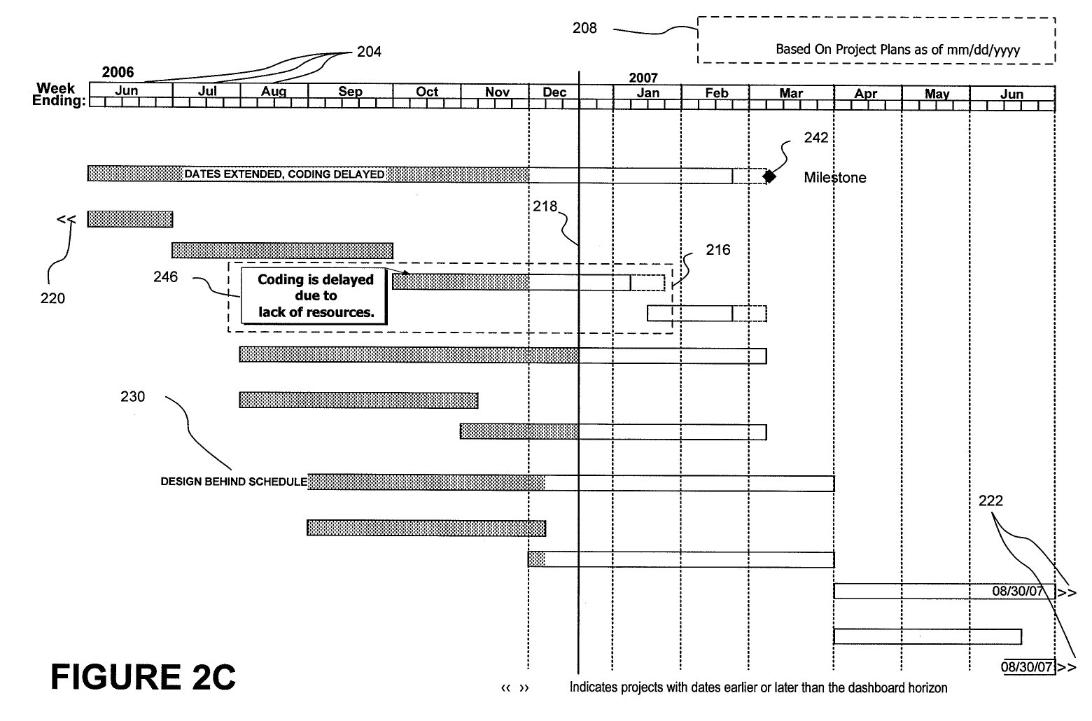

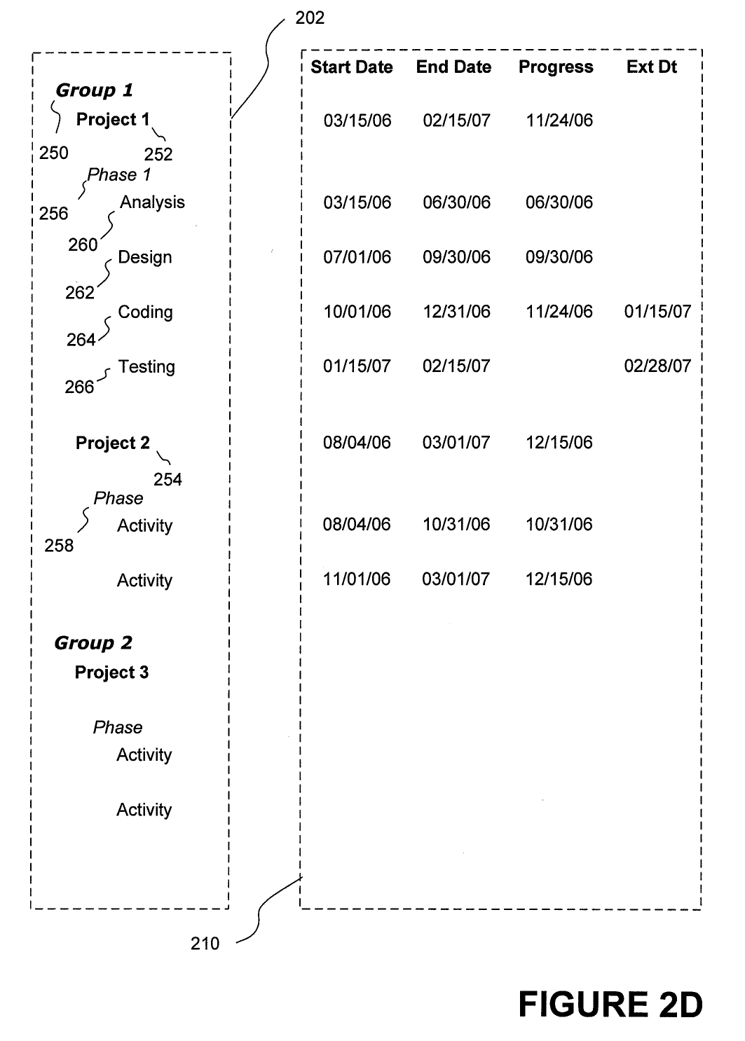

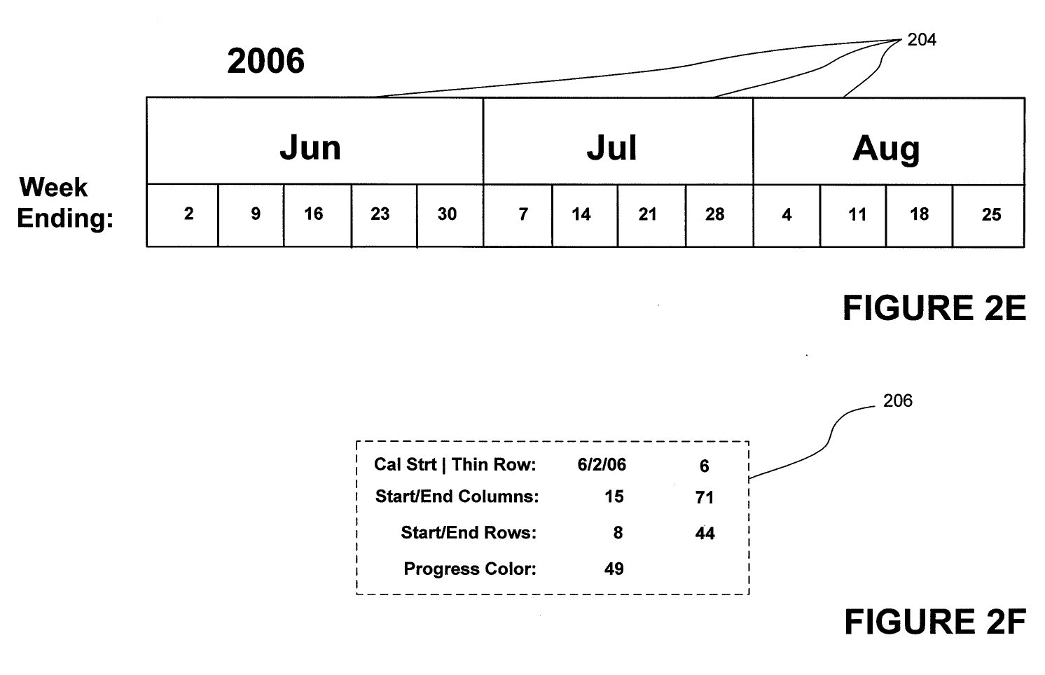

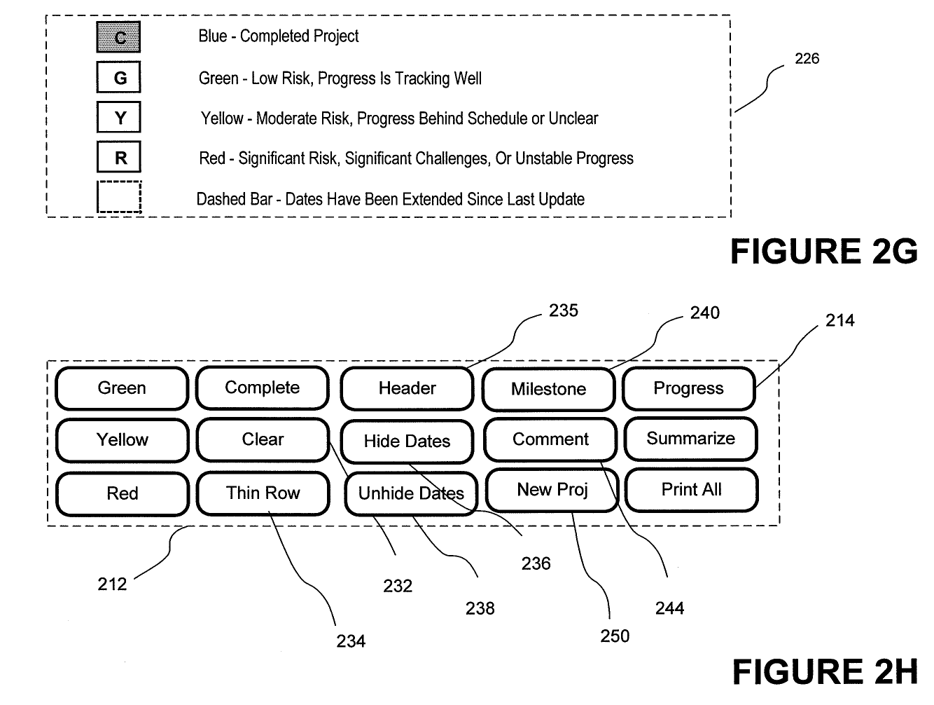

FIG. 2A shows a complete view of a screen from the weekly project evaluation tool 200. For visual clarity, portions of the weekly project evaluation tool 200 are shown enlarged in FIGS. 2B-2H.

A user enters project description information within rows of the description columns 202 (which are shown enlarged in FIG. 2B). In one implementation, the weekly project evaluation tool 200 allows for a collection of projects and subprojects to be evaluated to be subdivided to four levels: a group level, a project level, a phase level, and an activity level. A group can be divided into one more projects; a project can be divided into one or more phases; and a phase can be divided into one or more activities. In turn, an activity might involve more one or more tasks, as is further described below. In another implementation, individual tasks may be entered within an activity, thus creating a fifth hierarchical level. In addition, the tasks could be divided into one or more levels of sub-tasks, adding additional levels to the hierarchy. Further alternatively, in using the weekly project evaluation tool 200, it may be desirable to focus only on tasks within one or two phases, thus not all the levels need be employed in applying an implementation of the weekly project evaluation tool 200.

Although the project level in this implementation is a level recognized among the hierarchy of levels previously described, within the art the term “project” is commonly used to refer to the entirety of a job or operation as a whole. Accordingly, the inclusion of the project level in this implementation should not be taken—and would not be taken by one of ordinary skill in the art—as limiting the scope of implementations of the weekly project evaluation tool.

As is further described below, Gantt chart bars may be created for entries at all of these levels, including Gantt chart bars for every activity of every project or every phase, etc. Alternatively, the levels may be collapsed to present a Gantt chart bar that summarizes the tracking information for each entry within the collapsed level. For example, collapsing the entries within group will present for the group a single Gantt chart bar that summarizes each of the sub-levels for that group.

In using the weekly project evaluation tool 200, a user reviews the detailed tasks and project plan in the available project management data and groups these tasks into meaningful activities. The user then enters a description for the activities and the phases, projects, or groups into which they should be collected. In one implementation, the successive levels are nested within each other, such that entries for projects are indented under the heading for the group to which the project belongs, entries for phases are indented under the appropriate project heading, and activities are indented within the appropriate phase. Thus, in the example of FIG. 2A, the job “Group 1” 250 includes “Project 1” 252 and “Project 2” 254. Each of these groups includes one phase 256 and 258. The phase 256 under “Project 1” 252 includes four activities, including phases for Analysis 260, Design 262, Coding 264, and Testing 266.

A user can specify weekly time increments for the time horizon represented by the weekly project evaluation tool, or “evaluation horizon,” in the week columns 204 (shown in an enlarged view in FIG. 2E). There are many project management tools and applications commonly available that provide an unlimited set of user-specified time increments, but this weekly project evaluation tool only provides weekly time increments because this is a significant attribute of this invention.

In the input parameter fields 206 (shown in an enlarged view in FIG. 2F), a user specifies the overall calendar start date that indicates the beginning of the evaluation horizon. The user can specify a default row height to be applied when the “Thin Row” 234 button is clicked. The weekly project evaluation tool also includes fields that keep track of the start and end column numbers, and start and end row numbers of the evaluation horizon. The weekly project evaluation tool uses these column and row numbers as reference points in summarizing project data. The user can also specify a color code or other visually distinguishing code, such as a shading pattern, to be used for indicating progress by entering a color code index number in the progress color code field. In name cells 208, a user enters the overall project name and descriptive information for the project being evaluated.

Using tracking columns 210 (shown in an enlarged view alongside the description columns 202 in FIG. 2D for the sake of illustration), a user can then enter the Start Date, End Date, Progress Date, and Extension Date for each activity. The Start Date is the date the project activity begins. The End Date is the estimated completion date. The Progress Date is the date progress is considered complete for this project activity. The Extension Date is used to indicate that the End Date for this project activity has been delayed since the last version or update of the evaluation.

A user can determine the Progress Date by the following process. The user reviews the detailed tasks and project plan (which may be maintained separately in conventional project management software). Rather than determining progress based on completion percentage, the user determines which tasks have been fully completed (i.e., 100% completed).

For example, consider Project 1 252 referenced in description columns 202. Project 1 252 has one phase, Phase 1 256. Phase 1 256 has four activities, Analysis 260, Design 262, Coding 264, and Testing 266, common activities associated with computer software development lifecycle types of software development projects. Analysis is an activity that includes three tasks. If all three tasks are complete and the last task was completed on Jun. 30, 2006, the user enters 6/30/2006 as the Progress Date in the appropriate field of the tracking columns 210.

For sake of example, it is assumed that Coding 264 has three detailed tasks (not shown separately in this implementation of the weekly project evaluation tool) in a separate project plan. Task 1 began on Oct. 1, 2006 and was completed on Oct. 31, 2006. Task 2 began on Oct. 31, 2006 and completed on Nov. 24, 2006. Task 3 began on Nov. 24, 2006 and was originally estimated to be completed on Dec. 31, 2006, but due to project delays is now not estimated to be completed until Jan. 15, 2007. Because the first Coding task began on Oct. 31, 2006, the user enters 10/31/2006 as the Start Date. The user reviews these three detailed tasks and determines that Nov. 24, 2006 is the last date for the Coding activity that an individual task was fully completed. Therefore, the user enters 11/24/2006 as the Progress Date to reflect progress. This procedure is notably different from other common project management tools and applications, which rely on completion percentage to determine progress. Finally, the user evaluates that due to the delay of the third Coding task, the project now has an estimated completion date is later than what was previously planned. Therefore, the user enters 1/15/2007 as the End Date. The user performs the procedure described in this example for each activity and project contained in the weekly project evaluation tool.

Once the user enters all project description information and associated Start, End, Progress, and Extension Dates, the weekly project evaluation tool is now ready to generate a Gantt chart that graphically summarizes progress. Among the function buttons 212 (shown in an enlarged view in FIG. 2H), the user clicks on a Progress button 214. Each of the function buttons 212 performs an automated set of functions on the weekly project evaluation tool. The Progress button 214 generates and draws the Gantt chart portion of the weekly project evaluation tool. A Gantt chart is a graphical representation of the time related activities of projects using a calendar. Gantt charts contain horizontal bars, or Gantt bars, to graphically represent the duration of projects and activities. Gantt bars can be shaded to denote progress, and the time related portion of a project or activity that is considered to be complete. In this invention, upon clicking the Progress button 214, the weekly project evaluation tool generates the Gantt bars for every project activity in the weekly project evaluation tool that contains valid Start and End Dates.

The weekly project evaluation tool generates Gantt bars based on the start and end dates for each activity. If a project activity contains a progress date, the weekly project evaluation tool generation computer program shades a portion of the Gantt bar, up to and including the calendar week that contains the progress date. Chart 216 shows an example of how the weekly project evaluation tool draws a Gantt bar and shades progress based on the start, end, progress, and extension dates. The chart 216 includes a status bar 218, a vertical bar that the user can select and move horizontally across the evaluation horizon to indicate the current calendar week or status point. For one example, the user may select and move the status bar 218 by using a pointing device to manipulate a pointer to select the status bar 218, and then manipulate the pointing device to drag the status bar 218.

Project with progress shaded up to the status bar 218 are regarded as on schedule. Projects with progress shaded to the right of the status bar 218 are regarded as ahead of schedule. Projects with progress shaded to the left of the status bar 218 show white space (i.e., portions of the Gantt bar to the left of the Status Bar with no progress shaded). Per the procedure that is associated with this invention, this white space may be thought of as progress risk areas.

According to one implementation of the weekly project evaluation tool, project activities that have white space are progress risk areas due to any combination of the following reasons. First, the information and dates associated with individual tasks in the detailed, separate project plans are inaccurate or not current, causing the user to enter an older Progress Date as the last known date of task progress, thereby serving as a risk to the project since more current and accurate dates are unknown. Second, progress is behind schedule, thereby serving as a risk to the project since estimated completion dates may no longer be credible. Third, an individual task is significantly longer than one week and the status bar 218 lies in the midst of this task, making it unfeasible to shade progress until the task is complete, and thus, service as a risk to the project until the task is actually complete.

This third reason is commonly encountered in the management of projects. The weekly project evaluation tool considers this reason to be a project risk area because project tasks can have a tendency to drag on, with a false sense of confidence promoted by project management and progress evaluation methods and tools that solely rely on completion percentage. By using a process, or set of procedures, that determines progress based on the full completion of individual tasks, this invention avoids this common false sense of confidence and advocates project managers to break large tasks down into more manageable components that can be tracked with visibility to weekly completion milestones.

After generating the Gantt bars, the weekly project evaluation tool generates symbols for project activities that have dates that fall outside of the evaluation horizon. For example, in date carryover cells 220, the weekly project evaluation tool generates “<<” symbols for project activity start or end dates that are earlier than the evaluation horizon. In this example, the analysis activity of Project 1 began on Mar. 15, 2006 while the calendar start of the evaluation horizon is Jun. 2, 2006. In chart carryover cells 222, the weekly project evaluation tool draws >>symbols and labels the End Date for project activity start or end dates that are later than the evaluation horizon. In this example, the Project 4 End Date of Aug. 30, 2007 is later than the last weekly increment of the Weekly project evaluation tool Horizon, which is Jun. 29, 2007.

In the previous and current columns status 224, a user specifies the subjective or qualitative risk levels associated with each project. Clicking the Green, Yellow, Red, or Blue macro buttons 212 causes a Green, Yellow, Red, or Blue box to be drawn in the cell specified by the user. The legend 226 (shown in an enlarged view in FIG. 2G). describes each risk level. For example, a green box is meant to indicate a project has few risks, with progress tracking well. A red box is meant to indicate a project has significant risks that require some sort of attention or action, and so on. (For visual clarity in FIGS. 2A-H, the only color code actually shaded is for objects marked as complete, with a fill pattern of black dots on a white background. In one implementation, the codes would appear in the colors indicated.)

In the previous and current status columns 224, the “Previous column” refers to the user-specified risk levels previously associated with the projects in the weekly project evaluation tool, or risk levels before a user updates the current version of the weekly project evaluation tool. The Current column refers to the user-specified risk levels of the projects in the current version of the weekly project evaluation tool. In one implementation of the weekly project evaluation tool, a user copies the contents of the cells in the Current column to the Previous column before making any changes to the risk levels on the current column. In one implementation, the Previous column is shaded with a translucent white foreground to diminish the visual impact of the previous risk levels while emphasizing current risks and representing what risk levels have changed since the last iteration of the weekly project evaluation tool.

Because the exemplary implementation illustrated in FIGS. 2A-2H uses a commonly available spreadsheet application, a user can enter free form text to describe any row in the weekly project evaluation tool. For example, in the comment cell 230, a user enters “DESIGN BEHIND SCHEDULE” to further describe why Project 3 has a Yellow risk level.

Using the function buttons 214, a user can perform additional functions which automate common spreadsheet functions through the use of simple macros. For example, clicking a “Clear” 232 button clears the contents of a user-selected cell or range of cells. Clicking the “Thin Row” 234 button changes to the default row height to a thinner row height for a user-selected row to visually separate the rows between project groups, groups, phases, and activities more meaningfully. The default row height can be set in the user-defined input parameter fields 206. Clicking the “Header” button 235 generates the header title rows for the evaluation horizon 204 based on the calendar start date in parameters 206. Clicking the “Hide Dates” button 236 hides the Start, End, Progress, and Extension Date columns as well as the parameters 206.

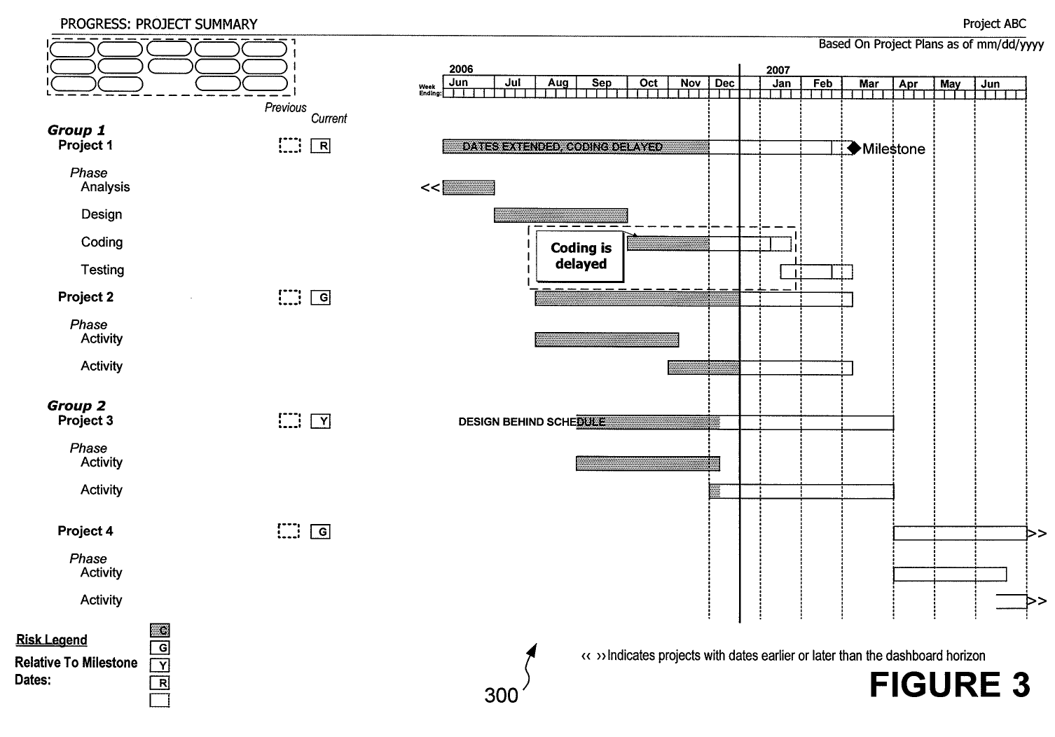

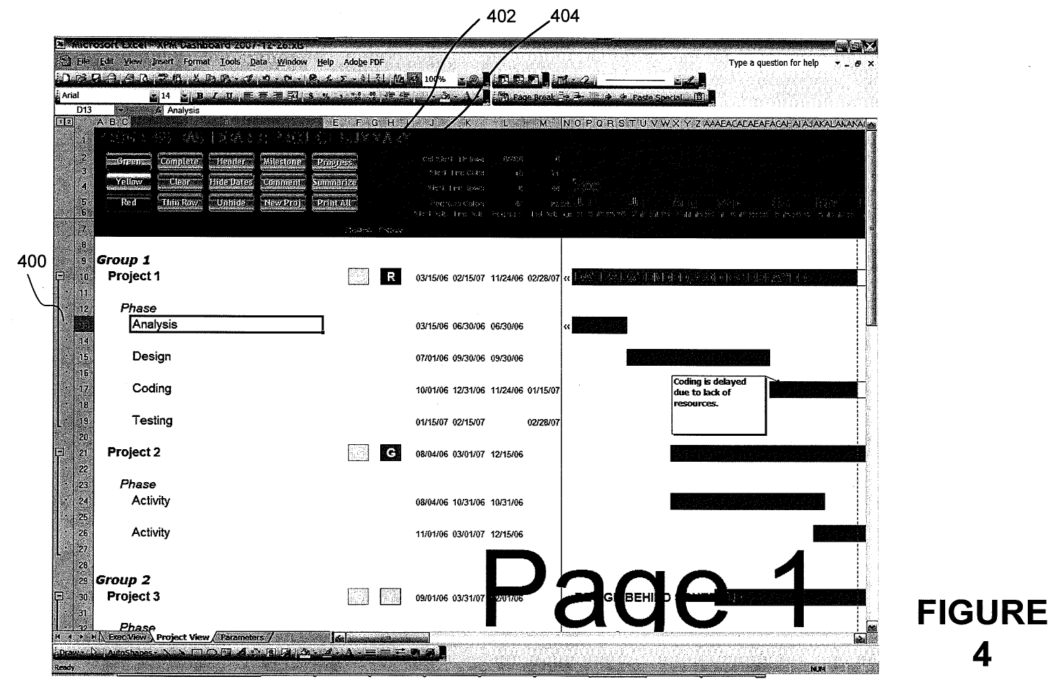

FIG. 3 illustrates a hidden dates view presented when the Hide Dates button 236 is clicked. Hiding these columns is desirable when printing the data, since it affords a cleaner, easier to understand visual representation. Clicking an “Unhide” button 238 reverses the above effect and reveals the Start, End, Progress, and Extension Date columns. Revealing, or unhiding, these columns allows a user to enter the Start, End, Progress, and Extension Dates for projects and activities. (FIG. 2A illustrates how the weekly project evaluation tool appears when the Unhide button is clicked.)

Clicking the “Milestone” button 240 draws a special milestone symbol in a user-specified cell and prompts the user to enter a brief milestone name or description to graphically show important milestones on the weekly project evaluation tool. For example, in the cells 242, clicking the milestone button 240 draws the milestone symbol, commonly accepted as a diamond, and generates the word “Milestone,” which can be modified by the user, in the cell immediately to the right of the cell containing the milestone symbol.

Clicking the “Comment” button 244 draws a preformatted comment box next to a user-specified cell and prompts the user to enter a brief description in the comment box. The comment box macro is activated by clicking the comment button 244 and relies on standard comment box functionality provided by the underlying spreadsheet application. For example, in the comment box 246, a user enters a brief comment to explain why coding is taking longer than expected.

Clicking the “New Proj” button 250 generates new rows that contain a template new project. This button only works when the user first selects an existing row that contains a project. The template rows that are generated are inserted above the user-selected row and are pre-filled with one project, one phase, two activities, and formulas that reflect the minimum and maximum start and end dates for the rows applicable to the newly created project. The user can then modify the project, phase, and activity names of these rows and insert or delete additional rows using standard spreadsheet functionality as desired.

A user may modify any information on the weekly project evaluation tool as often as desired and click the “Progress” or “Prog” button 214 to regenerate the weekly project evaluation tool at any time. The weekly project evaluation tool redraws the previously described project information each time the Progress button 214 is clicked based on the latest information provided by the user in the weekly project evaluation tool cells. The weekly project evaluation tool redraws Gantt bars for project activities with start and end dates and redraws indicator symbols for project activities with start and end dates that fall outside the evaluation horizon, but leaves any text the user enters in the evaluation horizon intact. The weekly project evaluation tool also leaves any user-specified comment boxes or milestones intact.

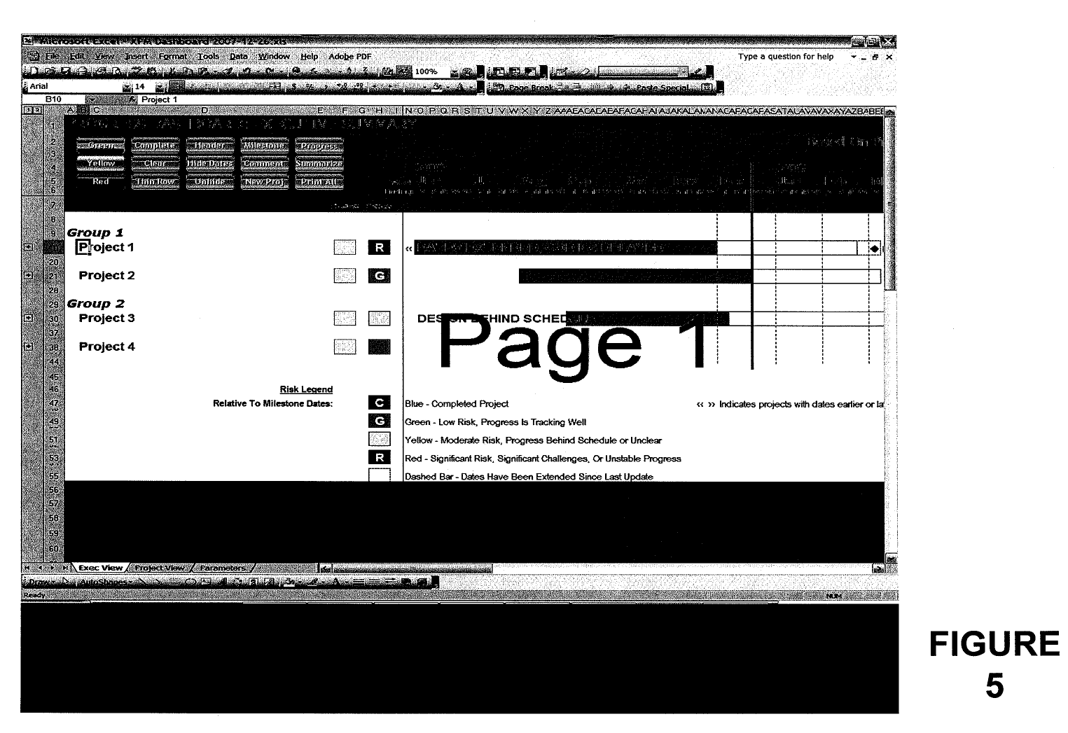

A user can expand or collapse the rows that contain the phases and activities of a project. For example, in FIG. 4, in the icon 400, a user can click on the small box with the “−” symbol to collapse the rows associated with Project 1. By doing so, the icon changes to a small box with a “+” symbol and only the row associated with Project 1 displays in the weekly project evaluation tool. The weekly project evaluation tool is formatted to capitalize on standard functionality of the underlying spreadsheet application to expand and collapse project rows.

In an implementation using a spreadsheet application, there are three worksheets in the view, making use of the multi-sheet capability of the underlying spreadsheet application: an Exec View worksheet, a Project View worksheet, and a Parameters View worksheet. A user enters the project information previously described and associated with the weekly project evaluation tool on the Project View worksheet.

Clicking the Summarize button 402, generates the Exec View, so that the weekly project evaluation information and project rows can be viewed on one executive level summary page, as illustrated in FIG. 5. The Summarize button 402 activates the Summarize macro, which collapses all project rows and removes all page breaks from the Project View and generates the Exec View as a separate sheet in the spreadsheet application.

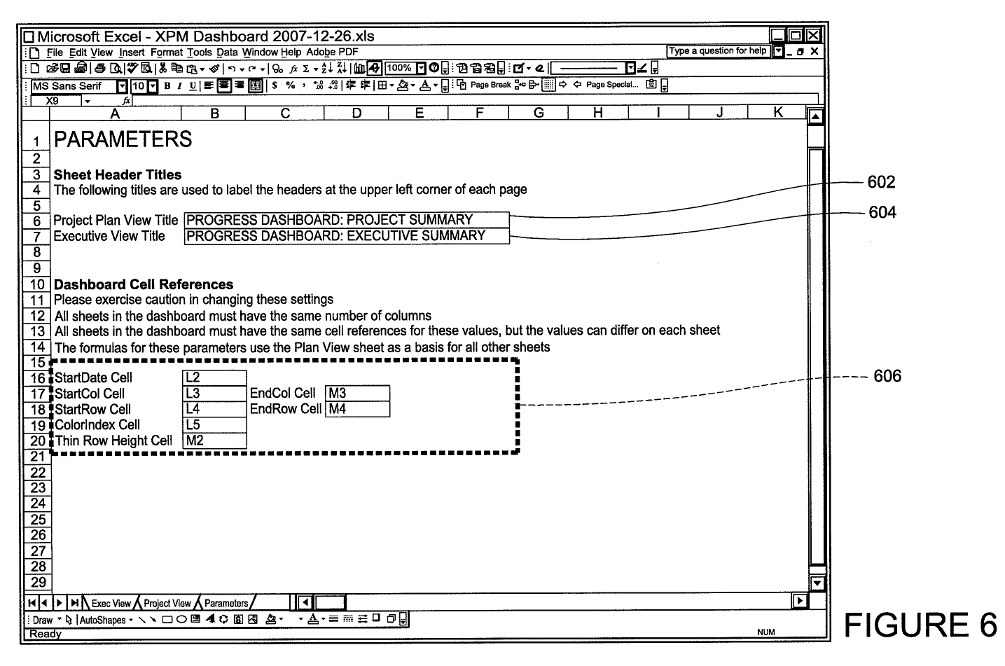

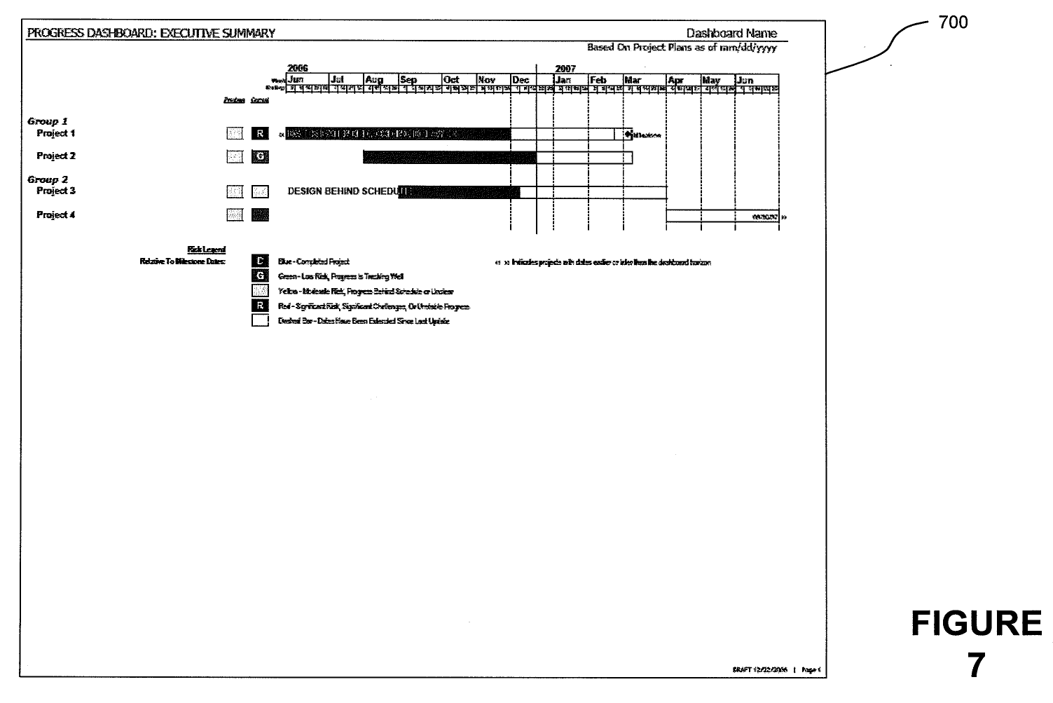

As illustrated in FIG. 6, a user specifies the cell references to be used by the weekly project evaluation tool on the parameters sheet. For example, in project title cells 602, a user specifies the title for the Project View, and in exec title cells 604, a user specifies a separate title for the Exec View. In the range cells 606, a user specifies the cell references that contain the start date, starting column, ending column, starting row, ending row, and progress color index of the evaluation horizon. The weekly project evaluation tool uses these parameters to generate the weekly project evaluation tool. By providing these parameters, the invention allows users to add or delete additional columns in the weekly project evaluation tool without impeding the logic performed by the weekly project evaluation tool. By using these parameters as variables, the weekly project evaluation tool can still function even if a user customizes or changes the number of columns in the weekly project evaluation tool. This sheet is typically hidden in the spreadsheet application since a user would rarely need to change these parameters once a new version of the weekly project evaluation tool is established.

Referring back to FIG. 4, clicking the Print All button 404, performs the functions of the Progress button and the Summarize button, and then readies the weekly project evaluation tool for printed output. A Print All macro is activated by clicking the Print All button 404 and relies on standard print preview functionality provided by the underlying spreadsheet application. This allows the user to preview the printed output on a computer screen before printing the weekly project evaluation tool output on paper.

FIG. 7 illustrates an example of an Exec View printed output 700, or an executive summary page. An object of the Exec View sheet is to provide, when possible, a single-page overview of the status of the project or group of projects of interest.

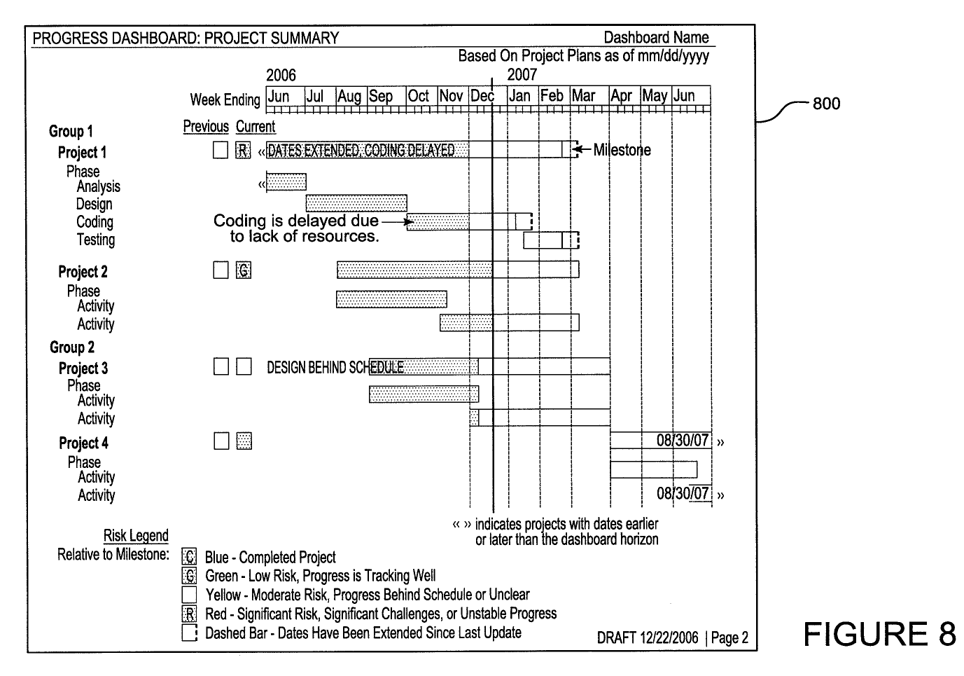

FIG. 8 illustrates an example of a Project View printed output 800, which includes more details and may consume many pages to chart the progress of all activities involved in the project or groups of projects of interest. In one implementation, the output pages include the titles specified by a user in the weekly project evaluation tool as header information. The output pages also include footer information, such as date printed. In an implementation that engages a spreadsheet application, a user can further customize the header and footer information using standard functionality in the spreadsheet application.

### Processes of Weekly Project Evaluation

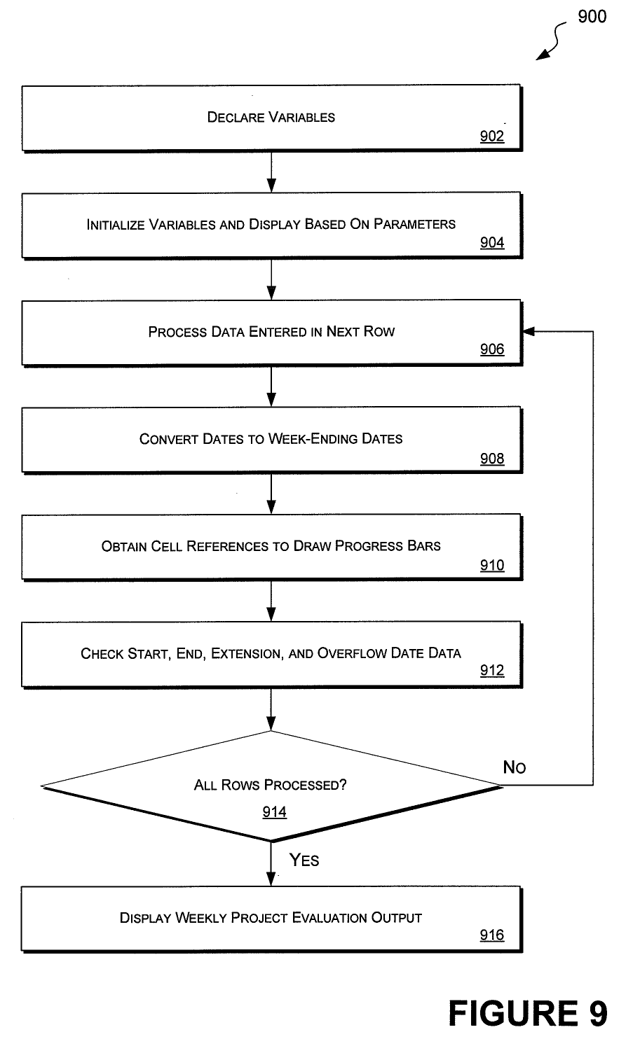

The process of weekly project evaluation may be a computer-implemented or a manual process. In one computer-based implementation, the weekly project evaluation tool contains a collection of visual basic algorithms that provide capabilities previously described. Source code for an exemplary implementation is listed below, and is described in relation to the flow diagram 900 of FIG. 9.

It should be noted that, in some of the accompanying figures and in the source code below, the weekly project evaluation tool, or the process of generating a visual display of the progress of the project, is referenced as a “dashboard.” This is a designation is a metaphor that, as in the case of the instruments arrayed on an automobile dashboard, a manager can view the information displayed by the weekly project evaluation tool and see, at a glance, what is the weekly progress of the project. The term dashboard thus is one way to suggest the functionality of the weekly project evaluation tool, but should not be considered a generic or descriptive name necessarily used in describing the weekly project evaluation tool.

At 902, the program begins by declaring variables or fields that will be used to store values and perform the calculations of the program.

Sub Dashboard( )
′
′ Dashboard Generation Computer Program/Macro
′ Generate Weekly Progress Based Gantt Chart & Executive Progress Dashboard
′
′
′ Declare variables
′

| | |
|---|---|
| Dim StartDate | ′timeline start date (Friday date) |
| Dim BaseCol | ′starting column number used for drawing progress bars |
| Dim EndCol | ′ending column number used for drawing progress bars |
| Dim StartRow | ′starting row used for drawing progress bars |
| Dim EndRow | ′ending row number used for drawing progress bars |
| Dim ProgColor | ′color index number for progress bars |
| Dim GRange$ | ′gantt chart range reference |
| Dim Cursor$ | ′cell reference of active cursor used to return cursor after drawing dashboard |
| Dim RowN | ′working row number used to increment do loop |
| Dim RN$ | ′row number as text used in cell references to draw dashboard |
| Dim SDRef$ | ′cell reference containing StartDate, requires named reference in spreadsheet |
| Dim SCRef$ | ′cell reference containing Starting Column for Gantt chart, requires named reference in |

spreadsheet

| | |
|---|---|
| Dim ECRef$ | ′cell reference containing Ending Column for Gantt chart, requires named reference in |

spreadsheet

| | |
|---|---|
| Dim SRRef$ | ′cell reference containing Starting Row for Gantt chart, requires named reference in |

spreadsheet

| | |
|---|---|
| Dim ERRef$ | ′cell reference containing Ending Row for Gantt Chart, requires named reference in |

spreadsheet

| | |
|---|---|
| Dim SDCol | ′column number containing base start date (before converting to Friday date) |
| Dim EDCol | ′column number containing base end date (before converting to Friday date) |
| Dim PDCol | ′column number containing base progress date (before converting to Friday date) |
| Dim XDCol | ′column number containing base ext date (before converting to Friday date) |
| Dim SBCol$ | ′column reference containing base start date (before converting to Friday date) |
| Dim EBCol$ | ′column reference containing base ebd date (before converting to Friday date) |
| Dim PBCol$ | ′column reference containing base progress date (before converting to Friday date) |
| Dim XBCol$ | ′column reference containing base ext date (before converting to Friday date) |
| Dim SDay | ′start date day of week |
| Dim EDay | ′end date day of week |
| Dim PDay | ′progress date day of week |
| Dim XDay | ′extension date day of week |
| Dim SCell$ | ′start date cell reference |
| Dim ECell$ | ′end date cell reference |
| Dim PCell$ | ′progress date cell reference |
| Dim XCell$ | ′extension date cell reference |
| Dim SFDate | ′start date converted to Friday date |
| Dim EFDate | ′end date converted to Friday date |
| Dim PFDate | ′progress date converted to Friday date |
| Dim XFDate | ′extension date converted to Friday date |
| Dim SCol | ′start column number for drawing progress bar |
| Dim ECol | ′end column number for drawing progress bar |
| Dim PCol | ′shade progress through column number for drawing progress bar |
| Dim XCol | ′column number for drawing extension bar |
| Dim Earlier | ′flag used to trigger earlier date indicators |
| Dim SSat | ′Saturday start day factor (used for converting to next Friday) |
| Dim Test$ | ′used to test for end of projects and drawing range |

′

Once the variables are defined, at 904, the weekly project evaluation tool initializes the program variables based on the parameters supplied to prepare to accept user input. The program uses the user-specified cell references from the Parameters sheet to establish reference points that are used by calculations in the program. During initialization, the program also unhides date columns 210 so that date values are available to be used by calculations in the program.

′ Unhide Start, End, Progress, Extension Date columns so dates appear
in later date indicators
′

Application.Run “Unhide”

′
′ Establish parameters and worksheet range references
′

SDRef$ = Range(“StartDate”).Text
SCRef$ = Range(“StartCol”).Text
ECRef$ = Range(“EndCol”).Text
SRRef$ = Range(“StartRow”).Text
ERRef$ = Range(“EndRow”).Text
StartDate = Range(SDRef$).Value
BaseCol = Range(SCRef$).Value
EndCol = Range(ECRef$).Value
StartRow = Range(SRRef$).Value
EndRow = Range(ERRef$).Value
ProgColor = Range(Range(“ProgColor”).Text).Value
GRange$ = Cells(StartRow, BaseCol).Address + “:” +
Cells(EndRow, EndCol + 1).Address
SDCol = BaseCol − 5
EDCol = BaseCol − 4
PDCol = BaseCol − 3
XDCol = BaseCol − 2
Cursor$ = ActiveCell.Address

′

At 906, this implementation of the weekly project evaluation tool then initializes a main routine for processing the data in each of the next rows. The program obtains the starting row number to initiative processing and initiates a nested do loop that repeats until the last row is encountered. The program clears each row of all previously drawn Gantt chart bars and overflow date indicators. In doing so, the program leaves all user specified text, comment boxes, and milestones in the evaluation horizon intact. At 908, an initial aspect of this process includes converting each user-supplied Start, End, Progress, and Extension Date into a Friday-based week-ending date. The program determines the week day of each date and for week days other than Fridays, converts the date to the following Friday.

′
′ Get starting row number
′

RowN = StartRow
RN$ = StartRow

′
′ Establish Do Loop
′

Do While Test$ <> “End”

′
′ Get and convert dates to Friday week ending dates
′

SCell$ = Cells(RowN, SDCol).Address
ECell$ = Cells(RowN, EDCol).Address
PCell$ = Cells(RowN, PDCol).Address
XCell$ = Cells(RowN, XDCol).Address
Test$ = Range(SCell$).Text
SSat = 0

′
′ Check if omit row indicator is set for the row
′ If so, do not clear the row and do not draw gantt bars
′

If (Cells(RowN, EndCol + 3).Text) = “x” Then

GoTo Increment

End If

′
′ Clear the row
′

Cells(RowN, BaseCol − 1).ClearContents
Cells(RowN, EndCol + 1).ClearContents
Cells(RowN, EndCol).ClearContents
Range(Cells(RowN, BaseCol − 1), Cells(RowN, EndCol +
1)).Select
Selection.Interior.ColorIndex = xlNone
Selection.Borders(xlDiagonalDown).LineStyle = xlNone
Selection.Borders(xlDiagonalUp).LineStyle = xlNone
Selection.Borders(xlEdgeLeft).LineStyle = xlNone
Selection.Borders(xlEdgeBottom).LineStyle = xlNone
Selection.Borders(xlEdgeRight).LineStyle = xlNone
Selection.Borders(xlInsideVertical).LineStyle = xlNone
Selection.Borders(xlInsideHorizontal).LineStyle = xlNone

′
′ Ensure valid dates before drawing new gantt bars
′

If Range(SCell$).Value > 0 And Range(ECell$).Value > 0 Then

SDay = Weekday(Range(SCell$).Value)

′
′ Test for Saturday start day of week; if Saturday, convert to following
Friday
′ (Weekday function yields 7 for Sat)
′

If SDay = 7 Then SSat = 7
SFDate = (6 − SDay) + Range(SCell$).Value + SSat
EDay = Weekday(Range(ECell$).Value)
EFDate = (6 − EDay) + Range(ECell$).Value
If Range(PCell$).Value > 0 Then

PDay = Weekday(Range(PCell$).Value)
PFDate = (6 − PDay) + Range(PCell$).Value

Else

PFDate = 0

End If
If Range(XCell$).Value > 0 Then

XDay = Weekday(Range(XCell$).Value)
XFDate = (6 − XDay) + Range(XCell$).Value

Else

XFDate = 0

End If′

The program specifically advocates the use of weekly time intervals to evaluate the full completion of task progress. A user can specify any date, which the program will convert to a Friday week ending date for the purpose of drawing the weekly project evaluation tool Gantt bars according to weekly intervals. However, a user cannot change the evaluation horizon time interval to an interval other than one week, as the program will not function properly.

It should be noted that, in one implementation, any dates entered by a user are converted to the next Friday date. This also applies to any dates that happen to fall on a Saturday or Sunday. Weekend dates are also converted to the next Friday date since that is when the full completion of task progress is likely to be observed. Alternatively, rather than converting all dates to the next Friday date, other conversion rules may be used. For example, dates falling on a Saturday might be converted to the immediately preceding Friday on the assumption that the user selected the Saturday date to represent the ending date of the preceding week. In such a case, it would make sense to convert dates falling on a Saturday to the date of the immediately preceding Friday to preserve what was intended to be the end of the week.

At 910, the implementation of the weekly project evaluation tool then obtains cell references for drawing the weekly project evaluation tool Gantt bars. The program determines the column numbers to be used to draw Gantt and progress bars. At 912, for each project activity that contains valid Start and End Dates, the program checks to see if Progress or Extension bars should be drawn, then draws Gantt bars, shaded progress bars, date extension bars, and date overflow indicators as applicable. At 914, it is determined if all the rows have been processed. If not, the flow diagram 900 loops to 906 to process the next row. In other words, the program loops and performs these functions for each row of the weekly project evaluation tool until it encounters the text “End” in the Start Date column. Once it is determined at 914 that all the rows have been processed, at 916, the weekly project evaluation output is presented, the program returns the cursor to its original position before the program was launched, hides the date columns 210, and ends execution. The source code below details these processes:

′
′ Get start, end, progress column numbers
′

SCol = (SFDate − StartDate)/7
ECol = (EFDate − StartDate)/7

′
′ Check if progress should be shaded
′

If PFDate > 0 Then

PCol = (PFDate − StartDate)/7

End If

′
′ Check if date extension exists
′

If XFDate > 0 Then

XCol = (XFDate − StartDate)/7

End If

′
′ Check if Start, End, Progress, or Extended Dates are earlier than Dashboard Horizon
′ If so, start drawing progress bars from first column and generate earlier date indicators
′

If SCol < 0 Then SCol = 0: Earlier = 1
If ECol < 0 Then ECol = 0: Earlier = 1
If PCol < 0 Then PCol = 0: Earlier = 1
If XCol < 0 Then PCol = 0: Earlier = 1
If Earlier = 1 Then

Cells(RowN, BaseCol − 1).FormulaR1C1 = “<<”
Earlier = 0

End If

′
′ Check if End Date is greater than Dashboard Horizon
′ If so, generate later date indicators
′

If ECol > (EndCol − BaseCol) Then

ECol = EndCol − BaseCol
Cells(RowN, EndCol).FormulaR1C1 = “ ” + MonthName(Month(Range(ECell$)), True) + “ ” +

Str(Year(Range(ECell$)))

Cells(RowN, EndCol + 1).FormulaR1C1 = “>>”

End If

′
′ Check if Extended Date is greater than Dashboard Horizon
′ If so, generate later date indicators
′

If XCol > (EndCol − BaseCol) Then

XCol = EndCol − BaseCol
ODate = Range(XCell$)
Cells(RowN, EndCol).FormulaR1C1 = “ ” + MonthName(Month(Range(XCell$)), True) + “ ” +

Str(Year(Range(XCell$)))

Cells(RowN, EndCol + 1).FormulaR1C1 = “>>”

End If

′
′ Check if Start Date is greater than Dashboard Horizon
′ If so, do not draw gantt bars
′

If SCol > (EndCol − BaseCol) Then

GoTo Increment

End If

′
′ Check if End Date is earlier than Start Date
′ If so, generate error message and do not draw gantt bars
′

If ECol < SCol Then

Response = MsgBox(“Row ” + RN$ + “ Invalid date: Please make sure the End Date is after the

Start Date.”, vbOKOnly, “Invalid Date”)

GoTo Increment

End If

′
′ Draw timeline
′

Range(Cells(RowN, BaseCol + SCol), Cells(RowN, BaseCol + ECol)).Select
Selection.Borders(xlDiagonalDown).LineStyle = xlNone
Selection.Borders(xlDiagonalUp).LineStyle = xlNone
With Selection.Borders(xlEdgeLeft)

.LineStyle = xlContinuous
.Weight = xlThin
.ColorIndex = xlAutomatic

End With
With Selection.Borders(xlEdgeTop)

.LineStyle = xlContinuous
.Weight = xlThin
.ColorIndex = xlAutomatic

End With
With Selection.Borders(xlEdgeBottom)

.LineStyle = xlContinuous
.Weight = xlThin
.ColorIndex = xlAutomatic

End With
With Selection.Borders(xlEdgeRight)

.LineStyle = xlContinuous
.Weight = xlThin
.ColorIndex = xlAutomatic

End With
Selection.Borders(xlInsideVertical).LineStyle = xlNone

′
′ Shade progress, if applicable
′

If PFDate > 0 Then

Range(Cells(RowN, BaseCol + SCol), Cells(RowN, BaseCol + PCol)).Select
Selection.Interior.ColorIndex = ProgColor

End If

′
′ Draw date extensions, if applicable
′

If XFDate > 0 And XFDate > EFDate Then

Range(Cells(RowN, BaseCol + ECol + 1), Cells(RowN, BaseCol + XCol)).Select
Selection.Borders(xlDiagonalDown).LineStyle = xlNone
Selection.Borders(xlDiagonalUp).LineStyle = xlNone
With Selection.Borders(xlEdgeLeft)

.LineStyle = xlContinuous
.Weight = xlThin
.ColorIndex = xlAutomatic

End With
WithSelection.Borders(xlEdgeTop)

.LineStyle = xlDash
.Weight = xlThin
.ColorIndex = xlAutomatic

End With
With Selection.Borders(xlEdgeBottom)

.LineStyle = xlDash
.Weight = xlThin
.ColorIndex = xlAutomatic

End With
With Selection.Borders(xlEdgeRight)

.LineStyle = xlDash
.Weight = xlThin
.ColorIndex = xlAutomatic

End With

End If

′
′ Draw date extension if Extended Date and End Date are the same (draws on box)
′

If XFDate > 0 And XFDate = EFDate Then

Range(Cells(RowN, BaseCol + XCol), Cells(RowN, BaseCol + XCol)).Select
Selection.Borders(xlDiagonalDown).LineStyle = xlNone
Selection.Borders(xlDiagonalUp).LineStyle = xlNone
With Selection.Borders(xlEdgeLeft)

.LineStyle = xlContinuous
.Weight = xlThin
.ColorIndex = xlAutomatic

End With
With Selection.Borders(xlEdgeTop)

.LineStyle = xlDash
.Weight = xlThin
.ColorIndex = xlAutomatic

End With
With Selection.Borders(xlEdgeBottom)

.LineStyle = xlDash
.Weight = xlThin
.ColorIndex = xlAutomatic

End With
With Selection.Borders(xlEdgeRight)

.LineStyle = xlDash
.Weight = xlThin
.ColorIndex = xlAutomatic

End With

End If

′
′ Increment row counters and loop
′

End If

Increment:

RowN = RowN + 1
RN$ = RN$ + 1
Loop

′
′ Position cursor at starting active cell reference
′

Range(Cursor$).Select

′
′ Hide Start, End, Progress, Extension Date columns
′

Application.Run “Hide”

End Sub

While the foregoing source code describes a process a computing system would follow in executing a method of a weekly project evaluation tool, the following description articulates actions a user would perform in making use of the weekly project evaluation tool. The may be thought of as a weekly or regularly schedule routine a user would follow to evaluate the progress of a project or collection of projects.

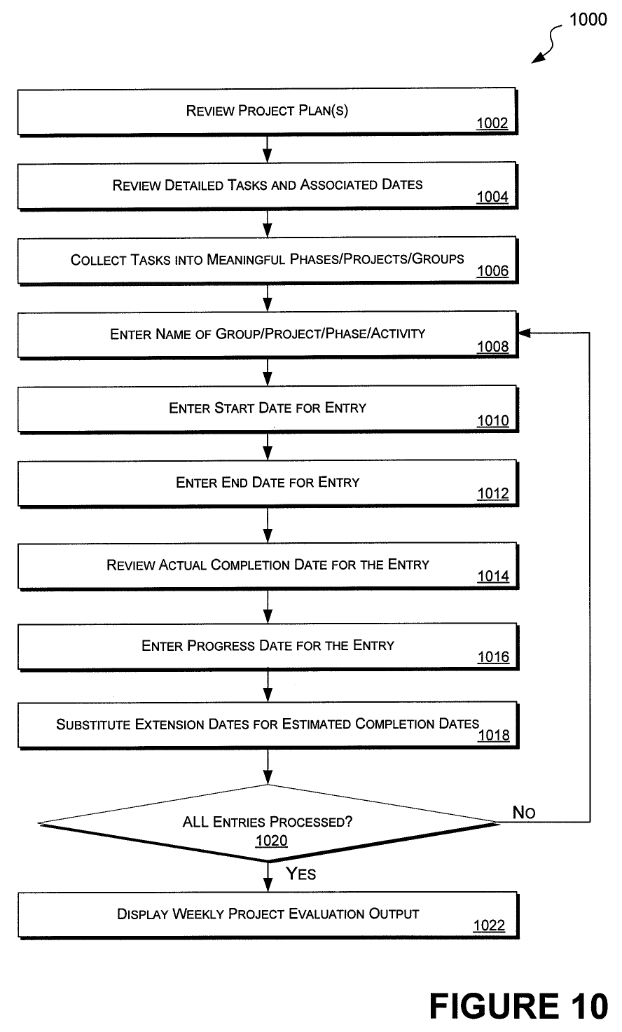

Flow diagram 1000 of FIG. 10 describes an implementation of a process a user would follow in performing weekly project evaluation. At 1002, a user reviews project plans that have been externally prepared manually or with conventional project management software applications. At 1004, for each job or project, the user specifically reviews the detailed tasks, start dates, end dates, duration, and completion status that are associated with each. At 1006, the user collects the tasks into meaningful collections including activities, phases, projects, or groups. For example, the user may use the four outline levels in the weekly project evaluation tool to meaningfully collect the tasks into groups of projects, projects, phases, and activities, as previously described.

At 1008, a user assigns or enters the name or description of project activity (or other classifications) into the weekly project evaluation tool. At 1010, a user assigns or enters the relevant start date. The start date may be considered the start date of the earliest task in the activity, phase, project, or group as the Start Date. At 1012, a user assigns or enters the relevant end date. The end date may be considered the end date of the latest task in the activity, phase, project, or group as the End Date. At 1014, a user determines progress by reviewing the actual completion dates of fully, or 100%, complete tasks within the project activity. If multiple tasks are complete with different completion dates, the user will consider the Progress Date to be the midpoint of the completed task completion dates. At 1016, a user assigns enters the Progress Date in the weekly project evaluation tool. At 1018, if the estimated completion dates of incomplete tasks have been delayed since the prior updated status or version of the weekly project evaluation tool, a user will consider the latest estimated completion date of the tasks within a project activity to be the Extension Date and enter the Extension Date in the weekly project evaluation tool.

At 1020, it is determined if the progress has been tabulated for each of the activities. If not, the flow diagram 1000 loops to 1008 to process the next collection of tasks. Once it is determined at 1020 that the progress has been tabulated for each of the activities, at 1022, the weekly project evaluation tool generates the output. As previously described, by selecting a Prog or Progress button on a computer-implemented tool, the progress will be reported for display and/or printing. It should be noted that, depending on the results and the user's desires, the user may repeatedly engaged the process described in flow diagram 1000.

This method may be performed manually, requiring the user to manually format a spreadsheet one cell at a time to achieve the graphical representation of weekly progress execution. However, this process is made more efficient and effective through the previously described system invention, the weekly project evaluation tool, which automates the portions of the weekly project evaluation tool process.

This invention graphically summarizes project progress using the associated method and system based on the weekly execution of project tasks. A user can input any project descriptions, grouped according to meaningful categories, with any associated start, end, progress, and extension dates. This invention is focused on summarizing project progress and is designed to be used in conjunction with other project management software applications and methods, rather than replacing them. This invention requires only a basic understanding of project management principles and the described method associated with this invention

As a result, this invention is compatible with virtually any other project management methods and tools, with minimal integration and interfacing considerations. A user can choose to develop custom interfaces to automate the transfer of data from other project management software applications to the weekly project evaluation tool, but this is not required to use this invention.

### Illustrative Operating Environment

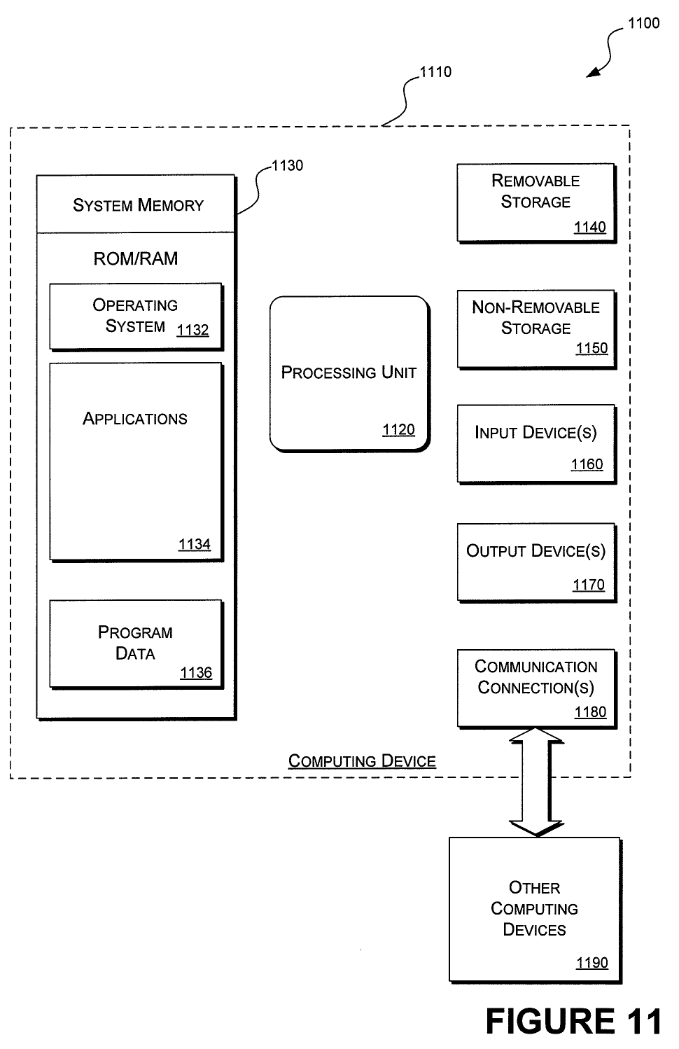

As previously described, in one implementation, the weekly project evaluation tool is manifested in computer-executable instructions stored in a computer-readable medium that can be processed by a computing system. One exemplary general purpose computing environment that would support execution of the weekly project evaluation tool is illustrated in FIG. 11.

FIG. 11 is a block diagram of a representative operating environment 1100 for the weekly project evaluation tool. The exemplary operating environment 1100 includes a computing device, such as computing device 1110. In a basic configuration, computing device 1110 may include a stationary computing device or a mobile computing device. Computing device 1110 typically includes at least one processing unit 1120 and system memory 1130. Depending on the exact configuration and type of computing device, system memory 1130 may be volatile (such as RAM), non-volatile (such as ROM, flash memory, and the like) or some combination of the two. System memory 1130 typically includes operating system 1132, one or more applications 1134, including one or more versions of the weekly project evaluation tool, and may include program data 1136.

The computing device 1110 may also have additional features or functionality. For example, computing device 1110 may also include additional data storage devices (removable and/or non-removable) such as, for example, magnetic disks, optical disks, or tape. Such additional storage is illustrated in FIG. 11 by removable storage 1140 and non-removable storage 1150. Computer storage media may include volatile and non-volatile, removable and non-removable media implemented in any method or technology for storage of information, such as computer readable instructions, data structures, program modules or other data. System memory 1130, removable storage 1140 and non-removable storage 1150 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1110. Any such computer storage media may be part of device 1110. Computing device 1110 may also have input device(s) 1160 such as a keyboard, mouse, pen, voice input device, touch input device, etc. Output device(s) 1170 such as a display, speakers, printer, etc. may also be included.

Computing device 1110 also contains communication connection(s) 1180 that allow the device to communicate with other computing devices 1190, such as over a network or a wireless network. Communication connection(s) 1180 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention is not limited by this specification.

1. A method, comprising:
collecting tasks relating to a project into one more collections, the collections including one or more of activities, phases, projects, and groups;
for the one or more tasks collected into the one or more collections:
assigning a start date for one or more of the tasks;
assigning a completion date for the one or more tasks;
convert the start date into a week ending start date of a start week in which the start date occurs; and
convert the end date into a week ending completion date of an end week in which the completion date occurs;
presenting a calendar spanning a selected period, the calendar representing each of the weeks in the selected period by a week end date for each of the weeks in the selected period;
providing a capability to receive information for the one or more tasks as to when the one or more tasks were at least one of started and completed; and
for one or more selected tasks to be presented on the calendar:
representing the one or more selected tasks with a visual representation of the task extending from the week ending start date to the week ending completion date of the task; and
a completion status according to whether the one or more tasks have been completed by the week ending completion date.
